(19) United States
(12) Patent Application Publication
(10) Pub. No.: US 2022/0108424 A1
(43) Pub. Date: Apr. 7, 2022

(54) METHOD AND DEVICE FOR IMAGE PROCESSING, AND STORAGE MEDIUM

(71) Applicant: SenseBrain Technology Limited LLC, Princeton, NJ (US)

(72) Inventors: Yufei Gan, Princeton, NJ (US); Jun Jiang, Princeton, NJ (US); Jinwei Gu, Princeton, NJ (US)

(21) Appl. No.: 17/554,006

(22) Filed: Dec. 17, 2021

(51) Int. Cl. G06T 3/40; G06N 3/08

(52) U.S. Cl. CPC G06T 3/4046; G06N 3/08; G06T 3/4015

(57) ABSTRACT

A method and device for image processing and computer storage medium are disclosed. In the method, red-green-blue (RGB) images corresponding to a raw image are obtained by demosaicing the raw image acquired by an image sensor; input data is obtained by downsampling the RGB images; and labeled data is generated according to the RGB images; and the input data and the labeled data are determined as training data for training the neural network.

### TECHNICAL FIELD

The present disclosure relates to computer visual processing techniques, and more particularly, to a method and device for image processing and computer storage medium.

### BACKGROUND

In the related art, a remosaic network is needed to process images having a quad bayer array. In a scenario of remosaicing an image, it is needed to train an upsampling neural network which is an important part of the remosaic network. When training the upsampling neural network, low-resolution input image data and high-resolution labeled image data corresponding to the input image will be obtained. In a practical scenario, how to obtain a pair of input image data and labeled image data is an urgent technical problem to be solved.

### SUMMARY

The embodiments of the present disclosure provide a method and device for image processing and computer storage medium.

An embodiment of the present disclosure provides a method for image processing including: obtaining red-green-blue (RGB) images corresponding to a raw image by demosaicing the raw image acquired by an image sensor; obtaining input data by downsampling the RGB images; and generating labeled data according to the RGB images; and determining the input data and the labeled data as training data for training the neural network.

An embodiment of the present disclosure also provides a device for image processing, including: a processor; and a memory for storing instructions executable by a processor, wherein the processor is configured to execute the instructions to perform operations of: obtaining RGB images corresponding to a raw image by demosaicing the raw image acquired by an image sensor; obtaining input data by downsampling the RGB images; and generating labeled data according to the RGB images; and determining the input data and the labeled data as training data for training the neural network.

An embodiment of the present disclosure also provides a non-transitory computer storage medium having stored thereon a computer program that, when executed by a processor, implements any of the above-described image processing methods.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of the specification, illustrate embodiments consistent with the present disclosure and, together with the description, serve to illustrate the technical solution of the disclosure.

FIG. 1 is a flowchart of a method for image processing in accordance with an embodiment of the present disclosure;

FIG. 2 is a schematic diagram of a color filter array of a raw Bayer image in an ideal scenario in accordance with an embodiment of the present disclosure.

FIG. 3A is a schematic diagram of an imaging principle of a 2×2 On-Chip Lens (OCL) sensor in accordance with an embodiment of the present disclosure.

FIG. 3B is 1×1 OCL image in accordance with an embodiment of the present disclosure.

FIG. 3C is an image acquired by a 2×2 OCL sensor in accordance with an embodiment of the present disclosure.

FIG. 4A is a schematic diagram of a principle of occurrence of sensitivity differences in accordance with an embodiment of the present disclosure.

FIG. 4B is another schematic diagram of a principle of occurrence of sensitivity differences in accordance with an embodiment of the present disclosure.

FIG. 4C is a schematic diagram of artifacts caused by sensitivity differences in accordance with an embodiment of the present disclosure.

FIG. 5 is a schematic diagram of a training flow for upsampling neural network in accordance with an embodiment of the present disclosure.

FIG. 6 is a flow chart of rearranging a mosaic of a to-be-processed image with a quad Bayer RGB array in accordance with an embodiment of the present disclosure;

FIG. 7 is another flow chart of rearranging a mosaic of a to-be-processed image having a quad Bayer RGB array in accordance with an embodiment of the present disclosure.

FIG. 8 is a flowchart of performing image processing using a trained upsampling neural network in accordance with an embodiment of the present disclosure.

FIG. 9 is a schematic structural diagram of an upsampling neural network in accordance with an embodiment of the present disclosure.

FIG. 10A is a first schematic structural diagram of a device for image processing in accordance with an embodiment of the present disclosure;

FIG. 10B is a second schematic structural diagram of a device for image processing in accordance with an embodiment of the present disclosure;

FIG. 10C is a third schematic structural diagram of a device for image processing in accordance with an embodiment of the present disclosure;

FIG. 11 is a schematic structural diagram of an electronic device in accordance with an embodiment of the present disclosure.

### DETAILED DESCRIPTION

The present disclosure is described in further detail below with reference to the accompanying drawings and examples. It is to be understood that the examples provided herein are merely illustrative of the disclosure and are not intended to limit the disclosure. In addition, the following examples are provided for carrying out some embodiments of the present disclosure, rather than providing all embodiments for carrying out the present disclosure. The technical solutions described in the embodiments of the present disclosure may be carried out in any combination without conflict.

It is to be noted that in the embodiments of the present disclosure, the terms “comprise”, “include”, or any other variation thereof, are intended to encompass a non-exclusive inclusion, such that a method or device including a series of elements includes not only the elements expressly recited, but also other elements not expressly listed, or elements inherent to the method or device. Without more limitations, an element defined by “including a . . . ”, does not exclude that other relevant elements (e.g., a step in a method or unit in a device, e.g., the unit may be part of a circuit, part of a processor, part of a program or software, etc.) exist in the method or device including the element.

For example, the image processing method provided in the embodiments of the present disclosure includes a series of steps. However, the image processing method provided in the embodiments of the present disclosure is not limited to the steps described. Similarly, the image processing device provided in the embodiments of the present disclosure includes a series of modules. However, the image processing device provided in the embodiments of the present disclosure is not limited to including the modules specifically described, and may further include the modules required for obtaining the related information or for processing based on the information.

The term “and/or,” as used herein, is merely an association that describes an associated object, meaning that there may be three relationships, for example, A and/or B may mean that A alone, both A and B, and B alone are present. Additionally, the term “at least one” as used herein denotes any combination of at least two of any one or more of a plurality, e.g., including at least one of A, B, C, may denote including any one or more elements selected from the group consisting of A, B, and C.

Embodiments of the present disclosure may be applied to computer systems comprised of terminals and/or servers, and may operate with various other general-purpose or special-purpose computing system environments or configurations. Here, the terminal may be a thin client, a thick client, a handheld or laptop device, a microprocessor-based system, a set-top box, a programmable consumer electronics product, a network personal computer, a small computer system, etc., and the server may be a small computer system, a large computer system, and a distributed cloud computing technology environment including any of the above systems, etc.

Electronic devices such as a terminal and a server may implement corresponding functions through execution of program modules. Generally, program modules may include routines, programs, target programs, components, logic, data structures, and the like. The computer system/server may be implemented in a distributed cloud computing environment in which tasks are performed by remote processing devices linked through a communication network. In a distributed cloud computing environment, program modules may be located on a local or remote computing system storage medium including a storage device.

Based on the application scenario described above, the disclosed embodiment provides a method for image processing.

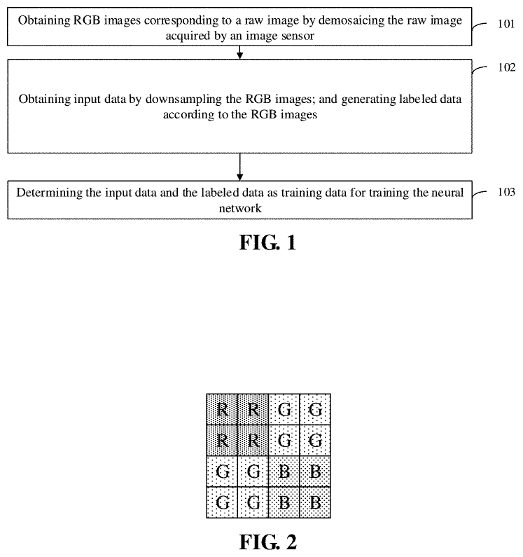

FIG. 1 is a flow chart of a method for image processing in accordance with an embodiment of the present disclosure. As illustrated in FIG. 1, the flow chart may include the following steps.

In step 101, a raw image acquired by the image sensor is demosaiced to obtain RGB images corresponding to the raw image.

Here, the color filter array of the image sensor is a quad bayer array, for example, the image sensor may be an image sensor such as an 2×2 OCL sensor, and a polarization sensor. The 2×2OCL sensor is a camera sensor, which can realize Phase Detection Auto Focus (PDAF) of full pixel phase detection, so that the focusing accuracy can be improved.

Exemplarily, the 2×2 OCL sensor may include an optical layer and a semiconductor layer, and the optical layer includes a lens and a Color Filter (CF). The semiconductor layer is provided with a photodiode as a photoelectric conversion section. The lens corresponding to the photodiode is arranged. The photodiode is arranged to photoelectrically converts light, which is input through an optical layer (i.e., a lens and a color filter) and is corresponding to the color of the color filter. In the semiconductor layer, the photodiodes are separated by separate portions. In an embodiment of the present disclosure, the separation portion may be an element manufactured based on Reverse-side Deep Trench Isolation (RDTI) process.

Exemplarily, in the case where the image sensor is a 2×2OCL sensor, the raw image captured by the image sensor described above is a raw Bayer image having a quad Bayer RGB array. In the embodiment of the present disclosure, the quad Bayer RGB array includes 4×4 pixels. The quad Bayer RGB array of the raw Bayer image includes a top left portion, a top right portion, a bottom left portion, and a bottom right portion. Each of the top left portion, the top right portion, the bottom left portion, and the bottom right portion has 2×2 pixels.

Each portion of the quad Bayer RGB array is separated into four phases in total. The pixel of the upper left region of each portion of the quad Bayer RGB array is the first phase, which may also be denoted as phase 00. The pixel of the upper right region of each portion of the quad Bayer RGB array is the second phase, which may also be denoted as phase 01. The pixel of the lower left region of each portion of the quad Bayer RGB array is the third phase, which may also be denoted as phase 10. The pixel of the lower right region of each portion of the quad Bayer RGB array is the fourth phase, which may also be denoted as phase 11.

Referring to FIG. 2, in an ideal scenario, the pixels of the upper left portion of the quad Bayer RGB array of the raw bayer image are R pixels of the same signal strength, the pixels of the upper right portion of the quad Bayer RGB array of the raw bayer image are G pixels of the same signal strength, and the lower left portion of the quad Bayer RGB array of the raw bayer image are G pixels of the same signal strength, and the pixels of the lower right portion of the quad Bayer RGB array of the raw bayer image are B pixels of the same signal strength.

In the 2×2OCL sensor, 2×2 pixels correspond to a microlens, which will result in a Phase Difference (PD) and a Sensitivity Difference (SD). Unlike FIG. 2, in the embodiment of the present disclosure, the raw Bayer image may also have at least one of a phase difference or a sensitivity difference.

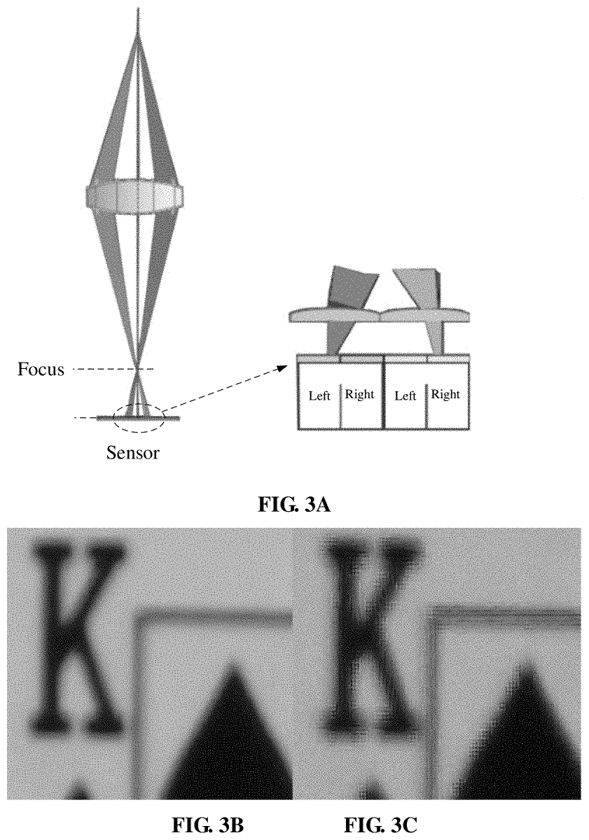

Here, the phase difference is an intrinsic disparity of the four phases coming from the structure of the shared lens. It can be viewed as viewpoint difference among the four sub-images extracted by corresponding phases; Or as pixel shift in a small window, thereby could cause artifacts such as duplicated edges without special processing For example, the imaging principle of the 2×2OCL sensor is illustrated in FIG. 3A. FIG. 3B illustrates 1×1OCL image, where 1×1OCL image is an image acquired with one-to-one correspondences between pixels and lenses, and FIG. 3C illustrates an image acquired with the 2×2OCL sensor. It can be seen that in FIG. 3C, duplicated edges occur due to phase differences compared to FIG. 3B.

The sensitivity difference is the difference among sensitivities of the pixels of the four phases of each portion in the quad Bayer RGB array. Due to processing limitations in the manufacturing process, the center of the microlens in the 2×2OCL sensor may not be fully aligned with the center of the 2×2 pixel, which may result in different photoelectric conversion efficiencies corresponding to the four phases of each portion in the image, i.e., an imbalance in photoelectric conversion efficiencies among the four phases in the image. When the incident light of the microlens is incident from the inclination angle, the sensitivity difference becomes more obvious.

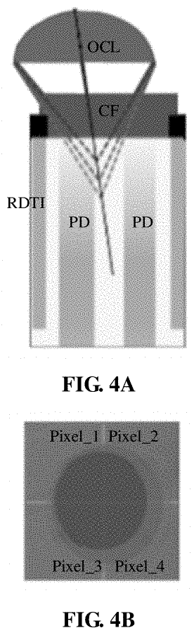

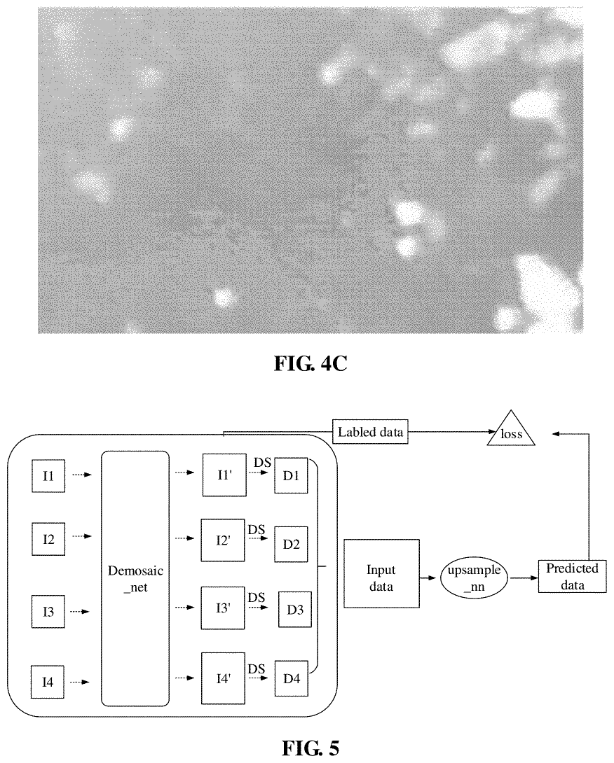

FIGS. 4A and 4B illustrate the principle of the occurrence of the sensitivity difference. In FIG. 4B, Pixel_1, Pixel_2, Pixel_3 and Pixel_4 represent four pixels having different phases, respectively. As can be seen from FIGS. 4A and 4B, when the incident light of the microlens is incident from the oblique angle, the raw Bayer image has the sensitivity difference. Referring to FIG. 4C, large sensitivity differences can cause artifacts in the raw Bayer image.

For example, in the case where the image sensor is a polarization sensor, the raw image captured by the image sensor described above includes images of four phases, and the raw image captured by the polarization sensor may have a phase difference due to different polarization angles of the four phases.

Exemplarily, in the case where the raw image is a raw Bayer image having a quad Bayer RGB array, the raw Bayer image may be separated into four single-phase Bayer images according to phases of pixels. Each of the four single-phase Bayer images is demosaiced to obtain an RGB image corresponding to the single-phase Bayer image.

In practical implementation, after the raw Bayer image is obtained, the pixels of the same phase in the raw Bayer image may be combined to obtain four single-phase Bayer images. Exemplarily, the pixels of the first phase of the raw Bayer image may be combined to obtain a first single-phase Bayer image. Similarly, the pixels of the second phase of the raw Bayer image may be combined to obtain the second single-phase Bayer image. The pixels of the third phase of the raw Bayer image may be combined to obtain the third single-phase Bayer image. The pixels of the fourth phase of the raw Bayer image may be combined to obtain the fourth single-phase Bayer image.

After obtaining four single-phase Bayer images, each single-phase Bayer image of the four single-phase Bayer images can be demosaiced to obtain an RGB image corresponding to the single-phase Bayer image.

In practical application, referring to FIG. 5, each single-phase Bayer image may be inputted to a pre-trained demosaic network, and demosaic processing is performed on each single-phase Bayer image by using the demosaic network to obtain an RGB image corresponding to the single-phase Bayer image. In FIG. 5, I1, I2, I3, and I4 denote four single-phase Bayer images, respectively, and I1′, I2′, I3′, and I4′ denote RGB images corresponding to the four single-phase Bayer images, respectively.

Here, the RGB image corresponding to each single-phase Bayer image includes the images of three channels, i.e., an image of R channel, an image of G channel, and an image of B channel.

In step 102, input data is obtained by downsampling the RGB images, and labeled data is generated according to the RGB images.

In an example, one image of the RGB images may be determined as the labeled data; or an average image of the RGB images may be determined as the labeled data

Referring to FIG. 5, I1′, I2′, I3′, and I4′ may be downsampled respectively to obtain the input data. In FIG. 5, the input data represents data obtained by stacking D1, D2, D3, and D4. D1 represents a result obtained by performing the downsampling processing on I1′, D2 represents a result obtained by performing the downssampling processing on I2′, D3 represents a result obtained by performing the downsampling processing on I3′, and D4 indicates a result obtained by performing the downsampling processing on I4′. Since the image data of each of D1, D2, D3, and D4 includes data of three color channels (i.e., R channel, G channel, and B channel), the image data of 12 channels may be obtained by stacking the image data of D1, D2, D3, and D4. That is, the input data is the image data of twelve channels.

In the embodiment of the present disclosure, since the pixel of the single-phase Bayer image is from a phase that is the same as the phase of the raw Bayer image, the RGB image corresponding to any single-phase Bayer image represents the image corresponding to the same phase of the raw Bayer image. With reference to the description of the phase difference and the sensitivity difference, it can be seen that the RGB image corresponding to any single-phase Bayer image does not have a phase difference and a sensitivity difference. Further, when the RGB images include RGB images corresponding to four single-phase Bayer images, the RGB image corresponding to any single-phase Bayer image of the four single-phase Bayer images is determined as the labeled data, the labeled data that does not have a phase difference and a sensitivity difference can be obtained, such that the training accuracy of the neural network can be improved.

In the embodiment of the present disclosure, the average image of the RGB images corresponding to the four single-phase bayer images does not have any phase difference or sensitivity difference. Because each average pixel can be viewed as a normal pixel under one corresponding micro-lens, avoiding any artifacts with shared micro-lens. Further, when the RGB images include RGB images corresponding to four single-phase bayer images, the average image of the RGB images corresponding to the four single-phase Bayer images is determined as labeled data, the labeled data that does not have the phase difference and the sensitivity difference can be obtained, such chat the training accuracy of the neural network can be improved.

Compared to the scheme of using an RGB image corresponding to any one single-phase bayer image as labeled data, the scheme of using the average image of the RGB images corresponding to the four single-phase Bayer images as labeled data has the following advantages: 1) signal-to-noise ratio is higher; 2) its effect is closer to the effect a real ordinary camera (1×1OCL sensor), because when using the average image of the RGB images corresponding to the four single-phase Bayer images as labeled data, it means that each pixel of the average image corresponds to one microlens, the average image is equivalent to the image captured by the ordinary 1×1OCL sensor, so that the depth information of the object which is photographed can be correctly reflected. In the scheme of using an RGB image corresponding to any one single-phase bayer image as labeled data, only a part of the imaging region of the microlens is used, so that there is an imaging effect of a camera with a small aperture.

In step 103, the input data and the labeled data are determined as training data for training the neural network.

In an example, the training data may be used for training an upsampling neural network which is a network for upsampling an image.

In the embodiment of the present disclosure, referring to FIG. 5, after the input data is obtained, the input data may be input to the upsampling neural network, and the input data is processed by the upsampling neural network to obtain prediction data. Then, the network parameter value of the upsampling neural network may be adjusted based on the prediction data and the labeled data.

In an embodiment of the present disclosure, the upsampling neural network is used for performing upsampling processing on the four RGB images having a phase difference or a sensitivity difference to obtain prediction data. Here, the prediction data represents high-resolution image data.

Referring to FIG. 5, in an implementation of adjusting the network parameter values of the upsampling neural network, a loss of the upsampling neural network from the prediction data and the labeled data is derived, and the network parameter values of the upsampling neural network are adjusted according to the loss of the upsampling neural network.

In an embodiment of the present disclosure, if the upsampling neural network having adjusted network parameter values does not meet the training completion condition, the steps of obtaining the labeled data and the input data for training the upsampling neural network, obtaining the prediction data, and adjusting the network parameter values of the upsampling neural network according to the prediction data and the labeled data may be performed again. If the upsampling neural network having adjusted network parameter values meets the training completion condition, the upsampling neural network having adjusted network parameter values is used as a trained upsampling neural network.

Exemplarily, the condition which determines that training is complete may be that the processing of the image by the upsampling neural network having adjusted network parameter values satisfies a set accuracy requirement. Here, the set accuracy requirement is related to the loss of the upsampling neural network. For example, the set accuracy requirement may be that the loss of the upsampling neural network is less than a set loss.

In the embodiment of the present disclosure, the image acquired by the various image sensors may be processed by using the upsampling neural network, the image stored locally or the image acquired from the network may be processed by using the upsampling neural network, or the pre-processed image may be processed by using the upsampling neural network. Here, the pre-processed image represents an image obtained by performing pre-processing such as demosaicing on an image.

In practical applications, steps 101 to 103 may be implemented with a processor in an electronic device, which may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing Unit (CPU), a Graphics Processing Unit (GPU), a controller, a microcontroller, or a microprocessor.

It will be appreciated that training data is important for the success of any data-driven method including deep learning, and therefore it is needed to acquire training data for a neural network to train the neural network before processing the image with the neural network. According to the contents described above, in the embodiments of the present disclosure, the labeled data can be generated according to the pre-trained demosaicing network, and the input data can be obtained by performing downsampling processing on the generated image of the demosaicing network. That is, in the case where the specific properties indicate that the images having a quad Bayer array can be captured, the embodiments of the present disclosure can easily obtain a pair of input data and labeled data according to the raw image acquired by various image sensors with specific properties and the pre-trained demosaicing network, such that labor cost and time cost of obtaining training data can be saved.

In an embodiment of the present disclosure, when the neural network is an upsampling neural network, the upsampling neural network may be applied in a scenario where the raw Bayer image is subjected to a remosaic processing.

Referring to FIG. 6, a to-be-processed image having a quad Bayer RGB array 601 may be remosaiced to obtain an image of the Bayer array 602. In the embodiment of the present disclosure, the to-be-processed image of the same type as the raw Bayer image. The Bayer array 602 is an array of 4×4 pixels, including 8 green pixels, 4 blue pixels, and 4 red pixels. The Bayer array includes 4 groups of 2×2 pixels, each group of 2×2 pixels includes 1 red pixel, 2 green pixels, and 1 blue pixel.

It is to be noted that the quad Bayer RGB array of the to-be-processed image in an ideal scenario is illustrated in FIG. 6, and the to-be-processed image may be an image having a phase difference or a sensitivity difference.

In the case where the to-be-processed image is an image having a phase difference or a sensitivity difference, the phase difference or the sensitivity difference may affect the process of the remosaic. Specifically, in a first aspect, the disparity level reflecting the degree of the phase difference is varied and complicated in an image, and the disparity level is related to the distance of an object from the focal plane. Generally, in an image, the relationship between the disparity levels of different pixels are complicated, and the correction process of the phase difference is difficult. In a second aspect, since sensitivity difference represents a difference between signal strengths of pixels of four phases, when the to-be-processed image has sensitivity difference, the sensitivity difference may decrease the quality of the image obtained by remosaicing.

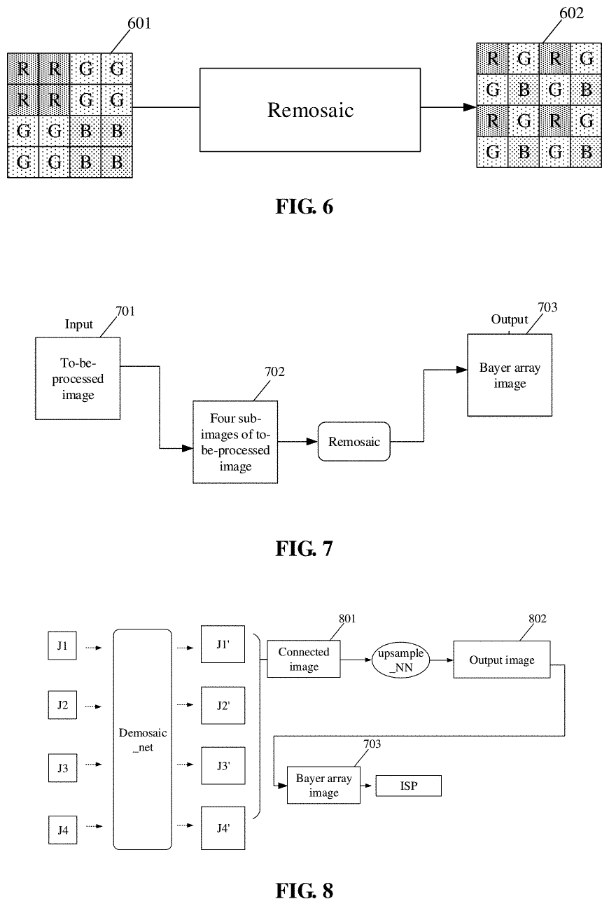

In an embodiment of the present disclosure, referring to FIG. 7, after acquiring the to-be-processed image 701 having a phase difference or a sensitivity difference, the to-be-processed image 701 having a phase difference or a sensitivity difference may be separated into four sub-images 702 of the to-be-processed image according to phases of the pixels. In the embodiment of the present disclosure, the to-be-processed image 701 is separated in the same manner as the manner in which the raw Bayer image is separated, details for which are not described herein.

After obtaining the four sub-images 702 of the to-be-processed image, the four sub-images 702 of the to-be-processed image may be remosaiced to obtain the Bayer array image 703. Exemplarily, the alignment and super-resolution processing may be implicitly performed on the four sub-images 702 of the four to-be-processed images by using the neural network to obtain the Bayer array image 703.

Exemplarily, in an implementation of remosaicing the four sub-images 702 of the to-be-processed image, each of the four sub-images 702 is demosaiced to obtain an RGB image corresponding to the sub-image, the RGB images corresponding to the four sub-images are inputted to a trained upsampling neural network, and the RGB images corresponding to the four sub-images are processed by using the trained upsampling neural network to obtain an output image, the output image is converted into the Bayer array image 703.

Referring to FIG. 8, each of the four sub-images 702 may be input to a pre-trained demosaic network, and each sub-image by the demosaic network demosaiced to obtain an RGB image corresponding to the sub-image. In FIG. 8, J1, J2, J3, and J4 represent four sub-images respectively, J1′, J2′, J3′, and J4′ represent the RGB images corresponding to the four sub-images respectively.

Here, the RGB image corresponding to each sub image includes the images of three channels, i.e., an image of R channel, an image of G channel, and an image of B channel.

Referring to FIG. 8, after obtaining the RGB images corresponding to the four sub-images, the RGB images corresponding to the four sub-images may be directly stacked, the image 801 obtained by stacking the RGB images is input to an upsampling neural network, and the stacked 12-channel image is processed by using the upsampling neural network to obtain the output image 802. After obtaining the output image 802, the output image 802 can be converted to the Bayer array image 703.

Exemplarily, after the Bayer array image 703 is obtained, the Bayer array image 703 may also be visually presented by Image Signal Processing (ISP). The ISP is primarily a unit for processing signals output from front-end image sensors to match image sensors from different manufacturers.

It will be appreciated that due to the complexity of the phase difference and the sensitivity difference, it is difficult to accurately correct the phase difference and the sensitivity difference in an image based on manually designed rules. In the embodiments of the present disclosure, after a pre-trained demosaic network is obtained, the upsampling neural network may be pre-trained using the idea of deep learning, and the pre-trained upsampling neural network are used to process the to-be-processed image to obtain the output image. Demosaic networks are relatively common networks for implementing image processing and have been widely used. In the embodiments of the present disclosure, a pre-trained mosaic network may be adopted for conversion of color filter arrays, a pre-trained upsampling neural network may be adopted for correcting complex phase difference and sensitivity difference, thereby simplifying the complex remosaic task.

Since the labeled data of the upsampling neural network does not have a phase difference and a sensitivity difference, the upsampling neural network has higher interpretation capability. Further, in the RGB space, the RGB images corresponding to the four sub-images are processed by using an upsampling neural network, so that the output image that does not have the phase difference and the sensitivity difference can be obtained, that is, the image processing accuracy of the remosaic task can be improved. For example, the image processing method of the embodiments of the present disclosure can improve factors such as remosaic artifacts and sawtooth, and the factors of remosaic artifacts can include factors such as resolution, false color, erroneous direction, and color mole.

As can be seen from FIGS. 7 and 8, the embodiment of the present disclosure may be implemented using the demosaic network and upsampling neural network shown in FIG. 8 for the remosaic tasks shown in FIG. 7. The output image can be viewed as an image obtained by super-resolution processing compared to the four sub-images of the to-be-processed image.

Exemplarily, the operation of obtaining the output image by processing the RGB images corresponding to the four sub-images with the trained neural network may include: obtaining a baseline image by upsampling any image of the RGB images corresponding to the four sub-images, or obtaining a baseline image by upsampling an average image of the RGB images corresponding to the four sub-images; obtaining output data of the neural network by processing the RGB images corresponding to the four sub-images with the neural network; and obtaining the output image by processing the baseline image and the output data.

Exemplarily, the methods of obtaining the baseline image, obtaining the output data, and obtaining the output image are implemented by a residual network in the neural network.

In an embodiment of the present disclosure, the output data of the neural network may be obtained by processing the RGB images corresponding to the four sub-images with the neural network layer of the residual network.

Here, by providing a baseline image to simplify the task of the neural network, it is possible for the neural network to learn only the residual, and therefore, it is easy to improve the accuracy of the neural network.

For example, when the label data is the RGB image corresponding to the i-th single phase Bayer image, the up-sampling process is performed on the image, which corresponds to the i-th single-phase Bayer image, of the RGB images corresponding to the four sub-images to obtain the baseline image. i is any one of 1, 2, 3, or 4.

Alternatively, when the label data is the average image of the RGB images corresponding to the four single-phase Bayer images, the upsampling process is performed on the average image of the RGB images corresponding to the four sub-images to obtain the baseline image.

Exemplarily, after the baseline image and the output data are obtained, the baseline image and the output data are added based on the residual connection to obtain the output image.

Here, the neural network layer of the residual network may include at least a convolutional layer and an upsampling layer. After the RGB images corresponding to the four sub-images are obtained, the RGB images corresponding to the four sub-images may be stacked, and the image obtained by the stacking processing may be input to the neural network layer.

In the neural network layer, the convolutional layer may be used to extract features, and the upsampling layer may be used to upsample the features. The output data of the neural network layer may be in the form of features or feature maps.

The structure of a residual network in an embodiment of the present disclosure will be described by way of example with reference to the accompanying drawings.

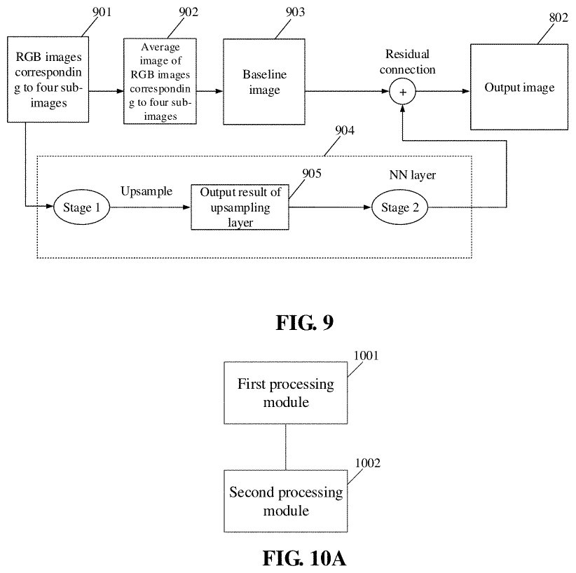

Referring to FIG. 9, an average image 902 of the RGB images 901 corresponding to the four sub-images can be obtained by averaging the RGB images 901 according to color channels. Then, the average image 902 of the RGB images corresponding to the four sub-images can be bilinear upsampled to obtain a baseline image 903.

Referring to FIG. 9, the RGB images 901 corresponding to the four sub-images are input to the neural network layer 904 of the residual network. Here, the RGB image corresponding to each sub image includes an image of R channel, an image of G channel, and an image of B channel, that is, the input data of the residual network is the RGB images of the I2 channels.

The process of performing image processing at the neural network layer 904 may be separated into at least a stage 1, an upsampling stage, and a stage 2. The stage 1 is used for feature extraction by using the convolutional layer, and the input data of the convolutional layer used in the stage 1 is RGB image corresponding to each sub-image, and the data amount of the RGB image corresponding to each sub-image is smaller than that of the to-be-processed image having the quad Bayer RGB array 601, so that the operation of the convolutional layer in the stage 1 can be realized at a lower calculation cost.

After the stage 1, the output result of the stage 1 can be upsampled by the using upsampling layer to obtain the output result 905 of the upsampling layer.

In the stage 2, features smoothing process between the four phases can be performed on the output result 905 of the upsampling layer through the convolutional layer, such that the processing quality of the image can be improved. The output data after stage 2 is the output data of the neural network layer.

After the baseline image and the output data are obtained, the baseline image and the output data can be added based on the residual connection to obtain the output image 802. The output image is an RGB image, and the height and the width of the output image 802 are both twice the RGB image corresponding to each sub-image.

Exemplarily, in the case where the neural network includes a residual network, the training process of the neural network may include: inputting input data to the neural network, and processing the input data by using the neural network to obtain a processing result corresponding to the input data; determining a loss of the neural network based on a processing result corresponding to the input data and the labeled data, adjusting the network parameter values of the neural network layer according to the loss of the neural network.

It can be seen that the embodiments of the present disclosure can improve the data processing accuracy of the residual network by adjusting the network parameter value of the residual network.

It will be appreciated by those skilled in the art that in the above methods of the detailed description, the order in which the steps are recited does not imply a strict order of execution or constitutes any limitation on the implementation process, and that the specific order of execution of the steps should be determined in terms of their function and possible intrinsic logic.

On the basis of the method for image processing proposed in the foregoing embodiment, the embodiments of the present disclosure proposes a device for image processing.

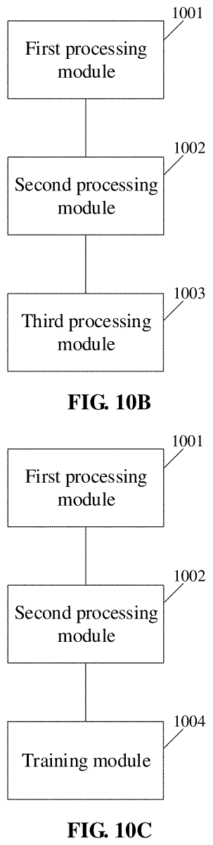

FIG. 10A is a schematic structural diagram of an image processing device in accordance with an embodiment of the present disclosure. As illustrated in FIG. 10, the device may include a first processing module 1001 and a second processing module 1002.

The first processing module 1001 is configured to obtain RGB images corresponding to a raw image by demosaicing the raw image acquired by an image sensor.

The second processing module 1002 is configured to obtain input data by downsampling the RGB images; and generating labeled data according to the RGB images.

The second processing module 1002 is further configured to determine the input data and the labeled data as training data for training the neural network.

In some embodiments, the second processing module 1002 is specifically configured to determine one image of the RGB images as the labeled data; or determine an average image of the RGB images as the labeled data

In some embodiments, the raw image includes a raw Bayer image having a quad Bayer RGB array.

The first processing module 1001 is specifically configured to separate the raw Bayer image into four single-phase Bayer images according to phases of pixels; and obtaining an RGB image corresponding to each of the four single-phase Bayer images by demosaicing the single-phase Bayer images.

The second processing module 1002 is specifically configured to determine one image of the RGB images corresponding to the four single-phase Bayer images as the labeled data; or determine an average image of the RGB images corresponding to the four single-phase Bayer images as the labeled data.

In some embodiments, referring to FIG. 10B, the device further includes a third processing module 1003, configured to: separate the to-be-processed image into four sub-images of the to-be-processed image according to phases of pixels, the to-be-processed image being an image having a quad Bayer RGB array; demosaicing each of the four sub-images to obtain an RGB image corresponding to the sub-image; inputting the RGB images corresponding to the four sub-images into a trained neural network, and obtaining an output image by processing the RGB images corresponding to the four sub-images with the trained neural network; and converting the output image to a Bayer array image.

In some embodiments, the third processing module 1003 is specifically configured to obtain a baseline image by upsampling any image of the RGB images corresponding to the four sub-images, or obtain a baseline image by upsampling an average image of the RGB images corresponding to the four sub-images; obtain output data of the neural network by processing the RGB images corresponding to the four sub-images with the neural network; and obtain the output image by processing the baseline image and the output data.

In some embodiments, the methods of obtaining the baseline image, obtaining the output data, and obtaining the output image are implemented by a residual network in the neural network.

In some embodiments, the RGB images include the RGB images corresponding to four single-phase Bayer images. The four single-phase Bayer images include a first to fourth single-phase Bayer images.

The third processing module 1003 is specifically configured to: when the labeled data is an RGB image corresponding to an i-th single-phase bayer image, obtain a baseline image by upsampling an image, which corresponds to the i-th single-phase bayer image, of the RGB images corresponding to the four sub-images, i being any one of 1, 2, 3, or 4; or when the labeled data for the neural network is an average image of the RGB images corresponding to the four single-phase bayer images, obtain a baseline image by upsampling the average image of the RGB images corresponding to the four sub-images.

In some embodiments, the third processing module 1003 is specifically configured to obtain an output image by adding the baseline image and the output data based on the residual connection.

In some embodiments, referring to FIG. 10C, the device further includes a training module 1004 configured to: input the input data to the neural network, and obtaining a processing result corresponding to the input data by processing the input data with the neural network; determine a loss of the neural network based on the processing result corresponding to the input data and the labeled data; and adjust a network parameter value of the residual network according to the loss of the neural network

It will be appreciated that training data is important for the success of any data-driven method including Deep Learning (DL), and therefore it is needed to acquire training data of the neural network to train the neural network before processing the image by using the neural network. According to the contents described above, in the embodiment of the present disclosure, the labeled data of the neural network can be generated according to the pre-trained demosaic network, and the input data from training the neural network can be obtained by downsampling images generated via the demosaic network. That is, in the case where the specific properties indicate that the image having the quad bayer array can be captured, the embodiments of the present disclosure can easily obtain the input data and the labeled data for the pairwise according to the raw image captured by the various image sensors having the specific properties and the pre-trained demosaic network, such that the labor cost and the time cost of obtaining the training data can be saved.

In practical application, the first processing module 1001, the second processing module 1002, the third processing module 1003 and the training module 1004 may all be implemented by a processor in a computer device. The processor may be at least one of an ASIC, a DSP, a DSPD, a PLD, an FPGA, a CPU, a GPU, a controller, a microcontroller, and a microprocessor.

In addition, the functional modules in the present embodiment may be integrated in one processing unit, or each unit may exist alone physically, or two or more units may be integrated in one unit. The integrated units described above may be implemented in the form of hardware or in the form of software functional modules.

The integrated unit, if not sold or used as a stand-alone product in the form of a software functional module, may be stored in a computer-readable storage medium. It is understood that the technical solution of the present embodiment may be embodied in the form of a software product in which instructions are included to cause a computer device (which may be a personal computer, a server, a network device, or the like) or a processor to perform all or part of the steps of the method described in the present embodiment. The storage medium includes a Universal Serial Bus (USB) flash drive, a removable hard disk, a Read Only Memory (ROM), a Random Access Memory (RAM), a magnetic disk, or an optical disk.

Specifically, computer program instructions corresponding to one of the image processing methods in the present embodiment may be stored on a storage medium such as an optical disk, a hard disk, or a USB flash disk. When the computer program instructions corresponding to one of the image processing methods in the storage medium are read or executed by an electronic device, any one of the image processing methods in the foregoing embodiments is implemented.

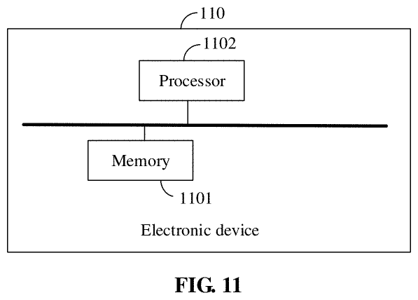

Based on the same technical concept of the foregoing embodiment, referring to FIG. 11, an electronic device 110 provided in an embodiment of the present disclosure may include a memory 1101 and a processor 1102.

The memory 1101 is configured to store a computer program and data.

The processor 1102 is configured to execute the computer program stored in the memory to implement any of the image processing methods of the foregoing embodiments.

In practical applications, the memory 1101 may be a volatile memory such as a Random access memory (RAM), or a non-volatile memory (non-volatile memory) such as Read-only memory (ROM), flash memory, Hard Disk Drive (HDD) or Solid-State Drive (SSD), or a combination thereof, and provides instructions and data to the processor 1102.

The processor 1102 may be at least one of an ASIC, a DSP, a DSPD, a PLD, an FPGA, a CPU, a controller, a microcontroller, and a microprocessor. It will be appreciated that for different devices, the electronics for implementing the above-described processor functions may be other electronics, and the embodiments of the present disclosure are not specifically limited.

Embodiments of the present disclosure also provide a computer program including computer readable codes that, when run in an electronic device, a processor in the electronic device performs any of the above-described image processing methods.

In some embodiments, the device provided by the embodiments of the present disclosure may have functions or include modules for performing the methods described in the above method embodiments, and specific implementations thereof may be described with reference to the above method embodiments, and details are not described herein for brevity.

The foregoing description of the various embodiments is intended to emphasize differences between the various embodiments, the same or similar may be referred to each other, and details are not described herein for the sake of brevity.

The methods disclosed in the various method embodiments provided herein can be combined arbitrarily without conflict to obtain new method embodiments.

The features disclosed in the various product embodiments provided herein can be combined arbitrarily without conflict to obtain new product embodiments.

The features disclosed in each method or device embodiment provided in the present application may be combined arbitrarily without conflict to obtain a new method embodiment or device embodiment.

From the above description of the embodiments, it will be apparent to those skilled in the art that the method of the above embodiments may be implemented by means of software plus the needed general hardware platform, but may be implemented by means of hardware, but in many cases the former is the preferred embodiment. Based on such an understanding, the technical solution of the present invention, in essence or in part contributing to the prior art, may be embodied in the form of a software product stored in a storage medium (such as a ROM, RAM, a magnetic disk, or an optical disk) including instructions for causing a terminal (which may be a mobile phone, a computer, a server, an air conditioner, or a network device) to perform the methods described in the various embodiments of the present invention.

Embodiments of the present invention have been described above in connection with the accompanying drawings, but the present invention is not limited to the foregoing detailed description, which is merely illustrative and not restrictive, and many forms may be conceived by those ordinary skilled in the art without departing from the spirit of the invention and the scope of the claims, all of which are within the protection of the invention.

1. A method for image processing, comprising:
obtaining red-green-blue (RGB) images corresponding to a raw image by demosaicing the raw image acquired by an image sensor;
obtaining input data by downsampling the RGB images; and generating labeled data according to the RGB images; and
determining the input data and the labeled data as training data for training the neural network.

2. The method of claim 1, wherein generating the labeled data according to the RGB images comprises:
determining one image of the RGB images as the labeled data; or
determining an average image of the RGB images as the labeled data.

3. The method of claim 2, wherein the raw image comprises a raw Bayer image having a quad Bayer RGB array,
wherein obtaining the RGB images corresponding to the raw image by demosaicing the raw image acquired by the image sensor comprises:
separating the raw Bayer image into four single-phase Bayer images according to phases of pixels, obtaining an RGB image corresponding to each of the four single-phase Bayer images by demosaicing the single-phase Bayer image,
and wherein determining one image of the RGB images as the labeled data comprises: determining one image of the RGB images corresponding to the four single-phase Bayer images as the labeled data;
determining the average image of the RGB images as the labeled data comprises: determining an average image of the RGB images corresponding to the four single-phase Bayer images as the labeled data.

4. The method of claim 1, further comprising:
separating a to-be-processed image to four sub-images of the to-be-processed image according to phases of pixels, wherein the to-be-processed image is an image having a quad Bayer RGB array;
obtaining an RGB image corresponding to each of the four sub-images by demosaicing the sub-image;
inputting the RGB images corresponding to the four sub-images into a trained neural network, and obtaining an output image by processing the RGB images corresponding to the four sub-images with the trained neural network; and
converting the output image to a Bayer array image.

5. The method of claim 4, wherein obtaining the output image by processing the RGB images corresponding to the four sub-images with the trained neural network comprises:
obtaining a baseline image by upsampling any image of the RGB images corresponding to the four sub-images, or obtaining a baseline image by upsampling an average image of the RGB images corresponding to the four sub-images;
obtaining output data of the neural network by processing the RGB images corresponding to the four sub-images with the neural network; and
obtaining the output image by processing the baseline image and the output data.

6. The method of claim 5, wherein methods of obtaining the baseline image, obtaining the output data, and obtaining the output image are implemented by a residual network in the neural network.

7. The method of claim 6, wherein the RGB images comprise RGB images corresponding to four single-phase bayer images, and the four single-phase bayer images comprise a bayer image of a first phase, a bayer image of a second phase, a bayer image of a third phase, and a bayer image of a fourth phase;
obtaining the baseline image by upsampling any image of the RGB images corresponding to the four sub-images or an average image of the RGB images corresponding to the four sub-images comprises:
when the labeled data is an RGB image corresponding to an i-th single-phase bayer image, obtaining a baseline image by upsampling an image, which corresponds to the i-th single-phase bayer image, of the RGB images corresponding to the four sub-images, i being any one of 1, 2, 3, or 4; or when the labeled data is an average image of the RGB images corresponding to the four single-phase bayer images, obtaining a baseline image by upsampling the average image of the RGB images corresponding to the four sub-images.

8. The method of claim 6, wherein obtaining the output image by processing the baseline image and the output data comprises:
obtaining the output image by adding the baseline image and the output data based on a residual connection.

9. The method of claim 6, wherein a training process of the neural network comprises:
inputting the input data to the neural network, and obtaining a processing result corresponding to the input data by processing the input data with the neural network;
determining a loss of the neural network based on the processing result corresponding to the input data and the labeled data; and
adjusting a network parameter value of the residual network according to the loss of the neural network.

10. A device for image processing, comprising:
a processor; and
a memory for storing instructions executable by a processor,
wherein the processor is configured to execute the instructions to perform operations of:
obtaining red-green-blue (RGB) images corresponding to a raw image by demosaicing the raw image acquired by an image sensor;
obtaining input data by downsampling the RGB images; and generating labeled data according to the RGB images; and
determining the input data and the labeled data as training data for training the neural network.

11. The device of claim 10, wherein the processor is further configured to execute the instructions to perform an operation of:
determining one image of the RGB images as the labeled data; or
determining an average image of the RGB images as the labeled data.

12. The device of claim 11, wherein the raw image comprises a raw Bayer image having a quad Bayer RGB array;
wherein the processor is further configured to execute the instructions to perform operations of:
separating the raw Bayer image into four single-phase Bayer images according to phases of pixels, obtaining an RGB image corresponding to each of the four single-phase Bayer images by demosaicing the single-phase Bayer image; and
determining one image of the RGB images corresponding to the four single-phase Bayer images as the labeled data; or determining an average image of the RGB images corresponding to the four single-phase Bayer images as the labeled data.

13. The device of claim 10, wherein the processor is further configured to execute the instructions to perform operations of:
separating a to-be-processed image to four sub-images of the to-be-processed image according to phases of pixels, wherein the to-be-processed image is an image having a quad Bayer RGB array;
obtaining an RGB image corresponding to each of the four sub-images by demosaicing the sub-image;
inputting the RGB images corresponding to the four sub-images into a trained neural network, and obtaining an output image by processing the RGB images corresponding to the four sub-images with the trained neural network; and
converting the output image to a Bayer array image.

14. The device of claim 13, wherein the processor is further configured to execute the instructions to perform an operation of:
obtaining a baseline image by upsampling any image of the RGB images corresponding to the four sub-images, or obtaining a baseline image by upsampling an average image of the RGB images corresponding to the four sub-images;
obtaining output data of the neural network by processing the RGB images corresponding to the four sub-images with the neural network; and
obtaining the output image by processing the baseline image and the output data.

15. The device of claim 14, wherein methods of obtaining the baseline image, obtaining the output data, and obtaining the output image are implemented by a residual network in the neural network.

16. The device of claim 15, wherein the RGB images comprise RGB images corresponding to four single-phase bayer images, and the four single-phase bayer images comprise a bayer image of a first phase, a bayer image of a second phase, a bayer image of a third phase, and a bayer image of a fourth phase;
the processor is further configured to execute the instructions to perform an operation of:
when the labeled data is an RGB image corresponding to an i-th single-phase bayer image, obtaining a baseline image by upsampling an image, which corresponds to the i-th single-phase bayer image, of the RGB images corresponding to the four sub-images, i being any one of 1, 2, 3, or 4; or when the labeled data is an average image of the RGB images corresponding to the four single-phase bayer images, obtaining a baseline image by upsampling the average image of the RGB images corresponding to the four sub-images.

17. The device of claim 15, wherein the processor is further configured to execute the instructions to perform an operation of:
obtaining the output image by adding the baseline image and the output data based on a residual connection.

18. The device of claim 15, wherein the processor is further configured to execute the instructions to perform operations of:
inputting the input data to the neural network, and obtaining a processing result corresponding to the input data by processing the input data with the neural network;
determining a loss of the neural network based on the processing result corresponding to the input data and the labeled data; and
adjusting a network parameter value of the residual network according to the loss of the neural network.

19. A non-transitory computer storage medium having stored thereon a computer program that, when executed by a processor, implements a method for image processing, the method comprising:
obtaining red-green-blue (RGB) images corresponding to a raw image by demosaicing the raw image acquired by an image sensor;
obtaining input data by downsampling the RGB images; and generating labeled data according to the RGB images; and
determining the input data and the labeled data as training data for training the neural network.

20. The non-transitory computer storage medium of claim 19, wherein the method further comprises:
separating a to-be-processed image to four sub-images of the to-be-processed image according to phases of pixels, wherein the to-be-processed image is an image having a quad Bayer RGB array;
obtaining an RGB image corresponding to each of the four sub-images by demosaicing the sub-image;
inputting the RGB images corresponding to the four sub-images into a trained neural network, and obtaining an output image by processing the RGB images corresponding to the four sub-images with the trained neural network; and
converting the output image to a Bayer array image.
